(19) United States
(12) Patent Application Publication
(10) Pub. No.: US 2008/0010881 A1
(43) Pub. Date: Jan. 17, 2008

(54) Dual function advertising platform

(75) Inventor: R. Scott Penza, Oakland, CA (US)

Correspondence Address: BRUCE & MCCOY, ONE KAISER PLAZA, STE. 750, OAKLAND, CA, 94612, US

(73) Assignee: POLE ROLL, INC.

(21) Appl. No.: 11/487,288

(22) Filed: Jul. 15, 2006

(51) Int. Cl. G09F 17/00

(52) U.S. Cl. 40/603

(57) ABSTRACT

A dual function advertising platform including a generally rectangular flexible pad having a first member of a hook and loop fastener pair secured to one side of the pad and the other member of a hook and loop faster pair secured to the opposite side of the pad and aligned on the pad with the first member whereby the pad can be wrapped around a pole and the hook and loop fastener members engaged to secure the pad to a pole whereby the pad provides an exposed surface to which advertising media can be attached for display.

### BACKGROUND OF THE INVENTION

1. Field of the Invention

The present invention relates to an apparatus and method for presenting billboard advertising in parking garages while protecting automobiles against self inflicted damage by providing protection pads for mounting on building structural supports such as concrete columns or steel poles to protect automobiles from damaging contact with the building supports where parking stalls in the garages are designated between the supports.

More particularly the present invention is a removable transportable self-supporting protective pad which can be wrapped around structural supports in a parking garage or structure to prevent damage to the sides of automobiles while the external surface of the pads can display billboard type advertising to produce revenue offsetting the cost of the pads.

Still more particularly the present invention is a dual function revenue producing cushioned advertising platform formed for wrapping around a support column in an automobile garage to protect cars parking in a garage from damage resulting from contact with the columns whereby the damage claims against the structures owner due to the narrow spaces allotted between the support columns are greatly reduced.

Specifically the present invention is a flexible rectangular cushioned pad which is designed in a configuration which can be easily wrapped around various diameter in circumference columns, poles, and building support structures, and secured thereto in self-supporting relation on the supports, and locked thereto with padlocks, to protect automobiles sides from damage and which provides a surface for billboard advertising with quick release tear away fasteners whereby the pads can be immediately removed to demonstrate they are not permanent billboards and that the advertising can easily be changed.

2. Description of the Prior Art

The use of a fixed advertising platform in one form or another for the purpose of enhancing the promotional efforts of selling commercial products, or for communicating and disseminating various information, is known in the prior art. However, despite the numerous designs, structures, and forms of apparatus disclosed by and utilized in the prior art, which have been developed for the accomplishment of the specific objectives, purposes, and requirements of product advertising and information dissemination, the devices, structures, apparatus, and methods which have been heretofor devised and utilized to accomplish these goals consist basically of familiar, expected, and obvious configurations, combinations, and arrangements of well known structural forms and apparatus. None of them however provide a dual function of presenting advertising media while protecting automobiles in parking structures which have structural supports interspaced between the designated parking stalls and which can cause damage to the sides of automobiles being parked in a designated space or extracted therefrom if the drivers are not especially careful. This will become apparent from the following consideration of the closest known and relevant prior art.

Advertising billboards are generally fixed in position and privately owned or erected and placed on leased property. Hand bills are sometimes illegally glued or affixed to utility poles and other public and private structures. In places like underground garages, or public parking structures, billboards and hand bills placed on the structures are usually prohibited because of their permanent or appearance degrading nature. Providing acceptable advertising media in such locations is very difficult to achieve due to the aesthetic considerations and local or governmental prohibitions.

Parking in garages and parking structures usually involves parking automobiles between structural supports which are usually made of concrete or cement encased frameworks and possibly steel poles or wood support structures. The designated parking spaces are usually quite narrow for reasons of economy to maximize the number of spaces. This fact results in considerable damage to automobiles during parking and extraction procedures. As a result, garages and parking structures are frequently blamed for the damage which in turn results in considerable additional operational expense for the parking space owners and operators. As a result, the owners and operators have long desired a solution to the problem, but essentially none have been forthcoming due to the increased expense of the proposed solutions. The present invention provides the solution to the problem with the unique characteristic of generating revenue to pay for the solution.

The dual function advertising platform contemplated according to the present invention departs substantially from the conventional concepts and designs taught and used by the prior art, and in doing so, provides an apparatus and method primarily developed for the purpose of overcoming the problems as described above, but it accomplishes the result in a different and improved manner for producing acceptable revenue income display advertising which can be more easily, conveniently, quickly, and economically replaced, changed, or removed. At the same time, the present invention concurrently provides the desired result, at little additional cost or effort, of protection to the sides of automobiles in parking garages having closely spaced parking stalls divided by supporting columns or poles such as in apartment buildings, shopping malls, cinema complexes, office buildings, public parking structures, and other similar parking configurations.

### SUMMARY OF THE INVENTION

In view of the foregoing known, obvious, and described disadvantages inherent in the known types of parking structure damage protection and the separate issue of billboard advertising in parking structures, presently existing in the prior art, the present invention provides a new method, apparatus, and construction for a dual function advertising platform wherein the same can be utilized to protect the sides of automobiles during parking into stalls divided by columns or poles while providing an optimum advertising platform.

The general purpose construction of the present invention, which will be described hereafter in greater detail, has been designed to provide a new and improved dual function advertising platform apparatus and method which has many of the advantages of the prior art of billboard advertising mentioned and described above plus the added benefit of reducing damage claims related to automobiles contacting the supports on which the advertising is placed. It is comprised of many novel features and advantages and performs the functions that result in a new dual function advertising platform which is not anticipated, rendered obvious, suggested, or even implied by any of the prior art of automobile damage protection and billboard advertising heretofore known, either alone or in any combination thereof.

The present invention is a dual function advertising platform formed for wrapping around one of the support columns in an automobile garage to display advertising media and to protect the sides of automobiles parking in the garage from damage due to the close proximity of the columns to the designated parking spaces in the garage. The advertising platform is comprised of a generally rectangular flexible cushioned pad formed to protect automobile side panels in the event an automobile parking in a designated parking space in the garage accidentally contacts a column or in the event a person inadvertently opens an automobile door which contacts a column. The pad is provided with a first member of a hook and loop fastener pair which is secured to one side of the pad. The other member of a hook and loop fastener pair is secured to the opposite side of the pad and aligned on the pad with the first member whereby the pad can be wrapped around a pole or column and the a hook and loop fastener members engaged to secure the pad to the pole whereby the pad provides an exposed surface to which advertising can be attached for display.

The present invention also includes the method of providing a dual concurrent function for posting billboard advertising in areas where such advertising is prohibited or discouraged while providing protection to automobiles in tight parking conditions bounded by building support columns or poles. The steps comprise providing protective pads with exterior advertising space which can be rolled into tubes and secured in such configuration with hook and loop fasteners; wrapping the pads around the poles in parking garages; and securing them thereto with a friction fit by engaging the hook and loop fasteners. Advertising media is attached to the exposed exterior of the pad for display when the pads are wrapped around the columns.

The more important features of the invention have been broadly outlined in the preceeding summary of the invention in order that the detailed description thereof which follows may be better understood and in order that the present contribution to an improvement in the art may be better appreciated. There are additional features of the invention that will be described hereinafter and which will form the subject matter of the claims appended hereto.

With respect to the claims hereof, and before describing at least one preferred embodiment of the invention in detail, it is to be understood that the invention is not to be limited in its application to the details of construction and to the arrangements of the components which are set forth in the following description or illustrated in the accompanying drawings. The invention is capable of being created in other embodiments and of being practiced and carried out in various ways. Also, it is to be understood that the phraseology and terminology employed here are for the purpose of description and should not be regarded as limiting.

As such, those skilled in the art in which the invention is based will appreciate that the conception upon which this disclosure is predicated may readily be utilized as a basis for the designing of other forms, structures, apparatus, systems, and methods for carrying out the several purposes of the present invention. It is important, therefore, that the claims be regarded as including such equivalent constructions in so far as they do not depart from the spirit and scope of the present invention.

Further, the purpose of the appended abstract is to enable the United States Patent and Trademark Office, and the public generally, and especially scientists, engineers and practitioners of the art who are not familiar with the patent and legal terms or phraseology, to determine quickly from cursory inspection the nature and essence of the technical disclosure of the application. The abstract is neither intended to define the invention of the specification, which is measured by the claims, nor is it intended to be limiting as to the scope of the invention in any way.

### OBJECTS OF THE INVENTION

It is therefore an important object of the present invention to provide a dual function advertising platform.

It is another object of the present invention to provide a low-cost long-lasting advertising platform which has an aesthetic appearance and can be easily and quickly emplaced, changed, or removed.

It is a further object of the present invention to provide a durable dual function advertising platform which can be affixed to support columns in automobile parking structures, and secured against theft, to protect the sides of automobiles against damage during the continuous parking and departure of automobiles into and from the parking stalls therein.

It is still another object of the present invention to provide a dual function advertising platform which permits cushioned pads, which are attached to parking garage support columns to prevent damage to automobiles, to generate advertising revenue to pay for the protective pads.

And it is yet a further object of the present invention to provide a method which accomplishes the same goal and results.

Other objects and advantages of the present invention will become apparent when the method and apparatus of the present invention are considered in conjunction with the accompanying drawings.

### DESCRIPTION OF THE DRAWINGS

The invention is illustrated in the accompanying drawings but not limited by reference to the particular embodiments shown therein of which:

FIG. 1 is a perspective view of a preferred embodiment of the present invention;

FIG. 2 is a plan view of an alternative embodiment of the present invention;

FIG. 3 is a an alternative plan view of still another embodiment of the present invention;

FIG. 4 is a broken out side elevation of a pocket for displaying advertising material in the present invention; and

FIG. 5 is a broken out side elevation of an alternative pocket for displaying advertising material in the present invention.

### DESCRIPTION OF THE PREFERRED EMBODIMENT

Reference is made to the drawings for a description of the preferred embodiment of the present invention wherein like reference numbers represent like elements on corresponding views.

The present invention is a dual function advertising platform formed for wrapping around a support column in an automobile garage or parking structure to protect automobiles parking in the garage or structure from damage due to the close proximity of the support columns to the designated parking spaces in the garage. The exterior surface on the platform is provided with means for displaying advertising media to generate revenue. This helps pay for the cost of using the pads to provide protection to automobiles and thereafter a continuing source of income.

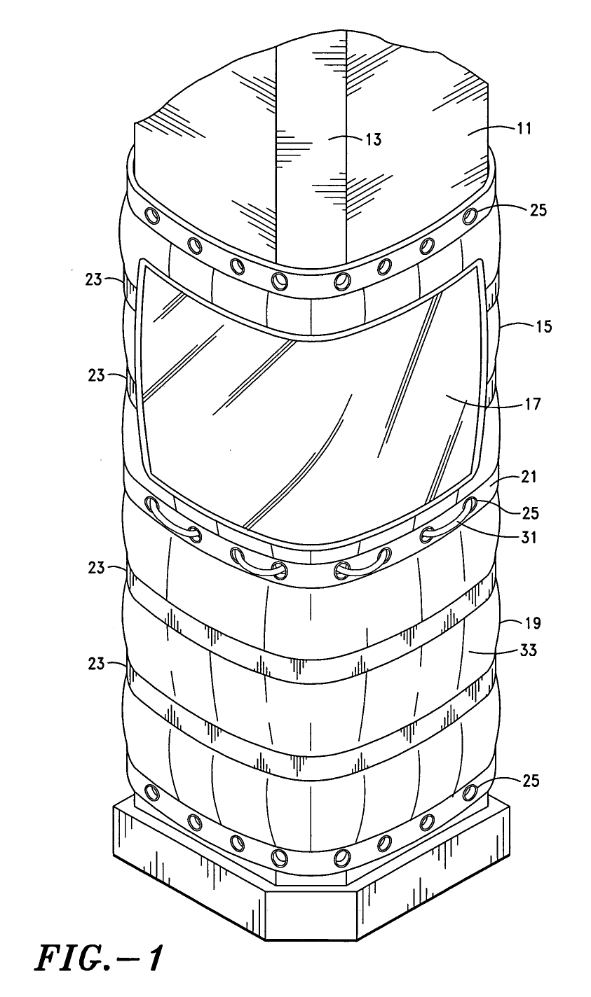

FIG. 1 shows a preferred embodiment of present invention mounted on a generally square concrete support column 11 having beveled corners 13. More often the columns are round but the present invention is self-supporting on the columns and can be fitted to any type of column due to its capability of self adjusting to any configuration and size of column. The invention can be made in various (horizontal) lengths to fit different ranges of column circumferences. The width thereof (top to bottom) determines the exposure height of the invention for providing advertising display space.

The advertising platform is a generally rectangular flexible cushioned pad 15 formed to protect automobile side panels in the event an automobile parking in a designated parking space accidentally contacts the column or in the event a person inadvertently opens a door which contacts the column. The pad exterior material is a woven synthetic fabric formed for providing strength and abrasion resistance.

FIG. 1 actually shows two pads: one above the other. The top pad is shown having a transparent plastic pocket 17 for displaying advertising media while the lower pad 19 is plain without a pocket. The advertising media pocket is removable and transferable whereby it can be secured to a plain pad whereby the pads are interchangeable top to bottom because the either of the top and bottom adjacent edges 21 can be interlocked. Thus a pad can be a protector with or without advertising depending upon its position on the column.

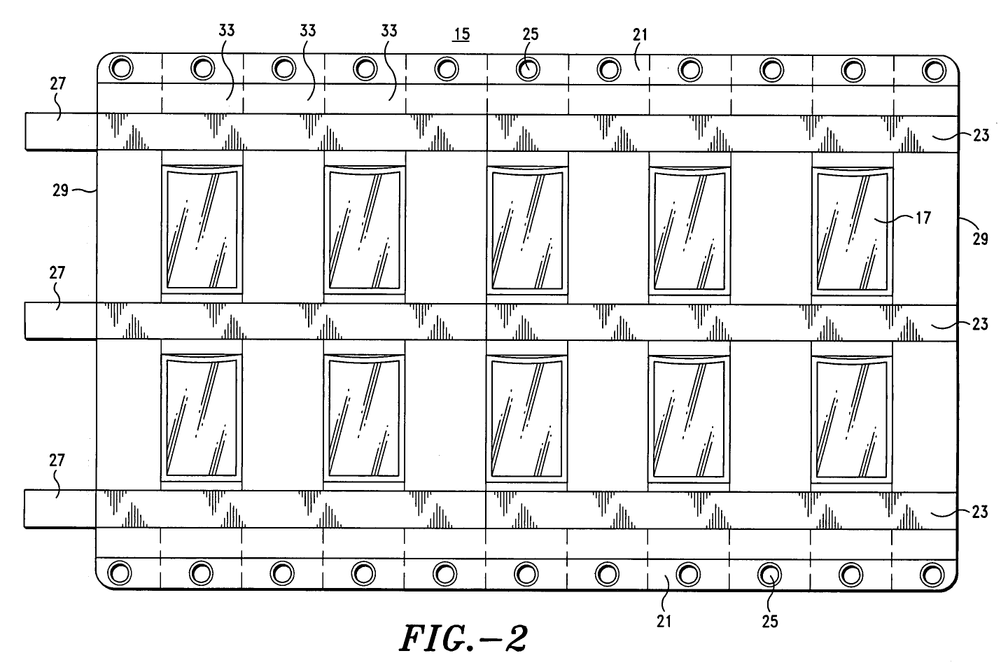

The two pads 15, 19 are interlocked by hook and loop fasteners 23 disposed proximate their adjacent edges in conjunction with a multiple of regularly spaced grommets 25. The hook and loop fasteners are disposed on both sides of the pad 15 so that two pads can be overlapped and hooked together in vertical alignment on the same garage support column. The member of a hook and loop fastener pair disposed on the outside of pad extends with a tail 27 from one vertical lateral edge 29 of the pad (see FIGS. 2 & 3) to provide an overlapping interlock.

After the pads are interlocked by the hook and loop fasteners, the pads can be secured to the support column by a cable threaded through aligned grommets on the two pads. The cable 31 ends can be connected by a padlock through loops at the ends thereof to secure the pads to the column. The inside of the pad faces the support column while the outside of the pad is visible to view (where it is not overlapped).

The hook and loop members 23 are secured parallel to the edges of the pad. At least a first member of a hook and loop fastener pair is secured to one side of the pad 15 and the other member of the pair is secured to the opposite side of the pad and aligned on the opposite side of the pad with the first member. A pad can be wrapped around a column or pole and the hook and loop fastener members wrapped tightly to engage and secure the pad to the column. The pad when it is wrapped around a column provides an exposed surface to which advertising media can be attached for display.

It is possible that smaller width pads (the height thereof when secured to a column) can be secured in position on a column with a single hook and loop pair, but for most pads suitable for protecting automobile side panels, multiple hook and loop pairs need to be secured proximate to at least the top and bottom edges of the pads and in most cases three hook and loop pairs are utilized: top and bottom edges and one pair mid height. The hook and loop members are disposed parallel to the top and bottom edges 21 of the pad adjacent to the grommets 25. The arrangement can be described generally as follows: the first member of the a hook and loop fastener pair is actually comprised of a multiple number of hook strips which are secured at intervals in parallel rows to at least the top and bottom edges of the pad and the other members of the a hook and loop fastener pairs is comprised of an equal multiple number of loop strips disposed at corresponding intervals on the opposite side of the pad aligned with the hook strips.

The loop members of the fastened pairs are preferably secured to the exterior surface of the pads to face outward so that contact of the automobile side panels with the pad results in contact with the softer member of the hook and loop fastener pairs, and the hook members are shielded from scratching the automobile finishes.

The advertising platform pad 15 is made of flexible fabric and is divided into vertically oriented individual compartments 33 containing cushioning material such as dense closed cell plastic foam. The compartments are formed by sewing vertical seams in the pad covers. Other cushioning material such as air chambers, hard sponge rubber, and compressible pelletized materials disposed in the compartments will function adequately for the purpose of providing a cushion. As a result of the longitudinal compartments, the pad has a minimal thickness between each of the compartments thereby allowing it to be more easily folded into a tubular, cylindrical, or other configuration for surrounding building support columns of variable shapes.

The dual function advertising platform of the pad includes horizontal reflecting tape disposed on the exterior side of the pad whereby when the pad is wrapped around a pole the tape can reflect automobile headlights to warn drivers of the location of columns in the driver's vicinity.

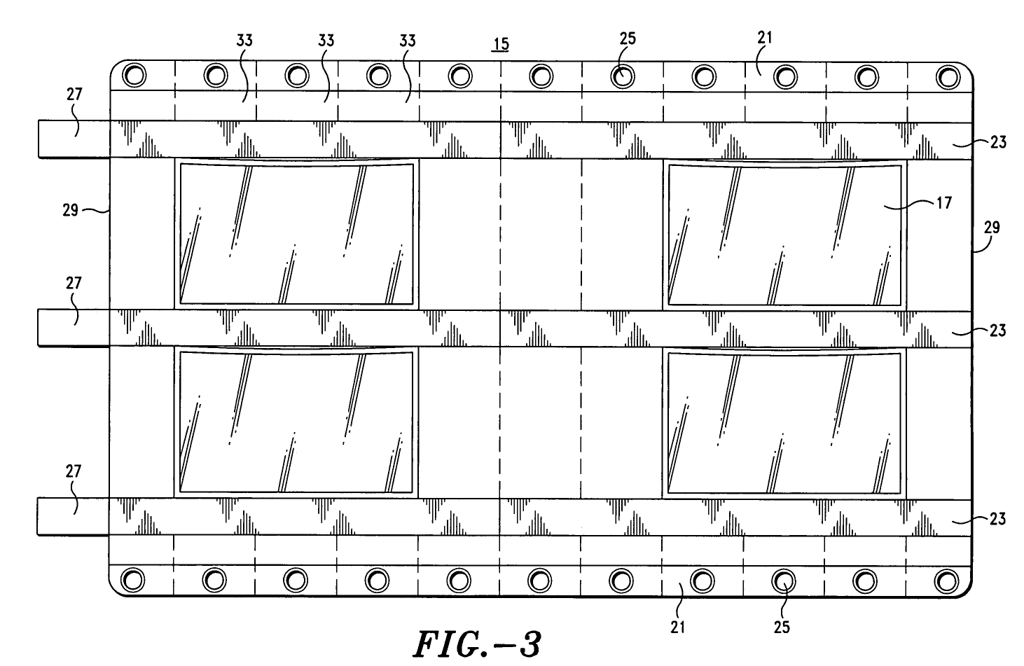

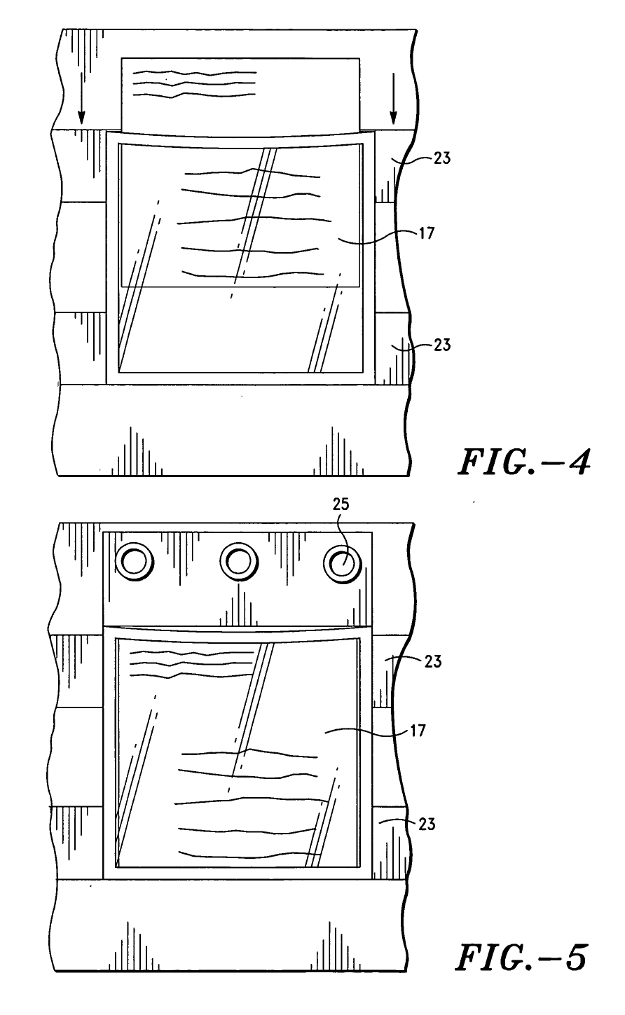

FIGS. 2-5 show variable forms of advertising display pockets 17 which can be attached to the pads 15. FIG. 2 shows multiple pockets secured to the individual compartments of a pad. Usually these would be sewn to the pad with an open end or side to permit advertising media to be inserted and exchanged. This type of pocket would be used on a narrow pole. FIG. 3 shows a larger display pocket with a larger window extending over several compartments. This type of pocket would be used on a larger sized column. FIG. 4 shows a pocket which can either be sewn to a pad or secured thereto with a hook and loop fastener member on the back of the pocket which engages the hook and loop opposite member on the pad.

FIG. 5 shows a display pocket 17 with grommets 25 at the top edge thereof which can be secured to the pad 15 the same as the pockets of FIG. 4. In addition it can be locked to a pad by the use of a locking cable woven through the aligned grommets on the pocket and pad the ends of which are interlocked.

The present invention also includes the method of providing a dual concurrent function and apparatus for providing billboard advertising in areas where such advertising is prohibited or discouraged while providing protection to automobiles in tight parking conditions bounded by building support columns or poles. The steps comprise: providing protective pads with exterior advertising space which can be rolled into tubes and secured in such configuration with hook and loop fasteners; wrapping the pads around the poles in parking garages and securing them thereto with a friction fit by engaging the hook and loop fasteners; and attaching advertising media to the exterior of the pad which is exposed when the pads are wrapped around the columns.

Thus it will be apparent from the foregoing description of the invention in its preferred form that it will fulfill all the objects and advantages attributable thereto. While it is illustrated and described in considerable detail herein, the invention is not to be limited to such details as have been set forth except as may be necessitated by the appended claims.

We claim:

1. A dual function advertising platform formed for wrapping around one of the support columns in an automobile garage to display advertising media and to protect automobiles parking in said garage from damage due to the close proximity of said columns to the designated parking spaces therein, said platform comprising
a generally rectangular flexible pad formed to protect car side panels in the event an automobile parking in a designated parking space in said garage accidentally contacts said column or in the event a person inadvertently opens an automobile door which contacts said column,
at least a first member of a hook and loop fastener pair secured to one side of said pad,
the other member of a hook and loop faster pair secured to the opposite side of said pad and aligned on said pad with said first member whereby said pad can be wrapped around a pole and said a hook and loop fastener members engaged to secure said pad to said pole whereby said pad provides an exposed surface to which advertising can be attached for display.

2. The dual function advertising platform of claim 1 wherein said pad is made of flexible fabric and is divided into vertically oriented individual compartments containing cushioning material whereby said pad has a minimal thickness between each of said compartments thereby allowing it to be more easily folded into a tubular or cylindrical configuration.

3. The dual function advertising platform of claim 1 where in said hook and loop fastener pair is disposed along the top edge of said pad and a second pair of correspondingly arranged hook and loop fasteners is disposed along the lower edge of said pad whereby two pads can be interlocked together in vertical alignment on the same garage support column.

4. The dual function advertising platform of claim 3 wherein said first member of said a hook and loop fastener pair is comprised of a multiple number of hook strips secured at intervals in parallel rows to at least the top and bottom edges of said pad and there between and said other member of said hook and loop fastener pair is comprised of an equal multiple number of loop strips disposed at corresponding intervals on the opposite side of said pad aligned with said hook strips.

5. The dual function advertising platform of claim 1 including horizontal reflecting tape disposed on the exterior side of said pad whereby when said pad is wrapped around a pole with said tape disposed on the external surface thereof said tape can reflect automobile headlights to warn drivers of said automobile of the location of said pole in said driver's vicinity.

6. The dual function advertising platform of claim 1 wherein said pad is provided with grommets disposed along at least one horizontal line parallel to the top and bottom edges thereof whereby a cable can be threaded alternately through said grommets and said pad can be padlocked to a pole when wrapped there around.

7. The dual function advertising platform of claim 1 wherein a first member of a hook and loop fastener pair extends from one vertical lateral edge of said pad whereby it can overlap the opposite edge of said pad to engage the other hook and loop member for extra gripping advantage.

8. The dual function advertising platform of claim 1 wherein display pockets have a flexible plastic transparent panel on the external side thereof and hook and loop material secured to the internal side thereof whereby it can be attached to the external surface of the advertising platform to display advertising media positioned in said pocket.

9. The dual function advertising platform of claim 8 wherein the top edge of said display pocket is provided with grommets which align with the grommets on said pad whereby said pocket can be locked to said pad by a cable threaded alternately through said grommets.

10. The method of providing a dual concurrent function and apparatus for providing billboard advertising in areas where such advertising is prohibited or discouraged while providing protection to automobiles in tight parking conditions bounded by building support columns or poles the steps comprising
providing protective pads with exterior advertising space which can be rolled into tubes and secured in such configuration with hook and loop fasteners,
wrapping said pads around said poles in parking garages and securing them thereto with a friction fit by engaging said hook and loop fasteners, and
attaching advertising media to the exterior of said pads which is exposed for display when said pads are wrapped around said poles.
